(19) United States
(12) Patent Application Publication
(10) Pub. No.: US 2021/0013828 A1
(43) Pub. Date: Jan. 14, 2021

(54) Damper assembly for single-axis tracker

(71) Applicant: Ojjo, Inc., San Rafael, CA (US)

(72) Inventors: Tyrus Hudson, Petaluma, CA (US); Jack West, San Rafael, CA (US); Katie Pesce, El Cerrito, CA (US); Greg McPheeters, Santa Cruz, CA (US)

(21) Appl. No.: 16/916,102

(22) Filed: Jun. 29, 2020

Related U.S. Application Data
(60) Provisional application No. 62/875,676, filed on Jul. 18, 2019.
(60) Provisional application No. 62/867,793, filed on Jun. 27, 2019.

(51) Int. Cl. H02S 20/32; H02S 30/00; F16M 11/10; F16M 11/18; F16M 13/02; F16F 9/02; F24S 40/00

(52) U.S. Cl. CPC H02S 20/32; H02S 30/00; F16M 11/10; F24S 40/00; F16M 13/02; F16F 9/0218; F16M 11/18

(57) ABSTRACT

A damper assembly for single-axis tracker supported by truss foundations. Truss leg damper brackets are attached to each truss leg and provide a fixed mounting point for the lower end of a damper spring. Different techniques may be used to effect mechanical engagement between the leg bracket and truss leg to prevent movement under load. Aligning each damper spring with a truss leg may eliminate moments that must ordinarily be resisted when damper springs are attached to a monopile foundation.

### CROSS-REFERENCE TO RELATED APPICATIONS

This claims priority to U.S. provisional patent application No: 62/930,098, filed Nov. 4, 2019, titled “Damper bracket for single-axis tracker,” 62/875,676 filed Jul. 28, 2019, titled “Single-axis tracker damper assembly for truss foundations,” and 62/867,793 filed Jun. 27, 2019, titled “Truss optimized damper system for single-axis trackers,” the disclosures of which are hereby incorporated by reference in their entirety.

### BACKGROUND

Wind striking a solar array will create static lateral loads that are translated into the foundation components securing the tracker to the ground. However, there is also a dynamic component to wind caused by turbulence and fluctuation across a tracker array that can produce resonance and rotation. These phenomena lead to system instabilities that can cause mechanical failures and in the worse-case, collapse of the structure. In order to resist these destructive dynamic forces, tracker makers now use damper springs that are attached to the foundation to brake resonance and unintended rotation. Dampers are like shock absorbers with a piston and gas or fluid reservoir that can be compressed or extended under slow, steady pressure but resists rapid impulses and oscillations, quickly retarding any wind impulses thereby protecting the system from damage.

Dampers are connected at one end to a moving part of the tracker array (e.g., torque tube bracket, module frame, module bracket, torque tube etc.) and at the other end fixed to the rigid foundation. If the tracker is supported by monopiles, (i.e., plumb driven H-piles), the lower end of each damper is connected to a bracket attached to one of the opposing flanges of the H-pile. In a conventional single-axis tracker, H-piles are driven along the intended North-South tracker row so that the opposing flanges face East-West while the web portion faces North and South. This consistent geometry allows holes to be pre-formed in each H-pile at a fixed distance from the head of the pile to support a brackets for the lower end of each damper. Depending on the type of tracker, one damper may be used on each flange of the H-pile, requiring two sets of holes. Alternatively, a single damper or damper and spring assembly may be used.

The applicant of this disclosure has proposed a new type of foundation for supporting single-axis trackers and other structures known commercially as EARTH TRUSS. EARTH TRUSS consists of a pair of adjacent rounded two-piece legs extending above and below ground that are joined together at the top with an adapter, bearing support or bearing adapter, depending on the specific configuration and tracker being supported. The legs in each truss pair are angled toward each other and extend over an intended North-South rotational axis of the tracker row. EARTH TRUSS provides advantages relative to monopile foundations by translating lateral loads on the array into axial forces of tension and compression in the truss legs rather than translating them into bending moments, as happens with monopiles. This enables less steel to be used when supporting single axis tracker relative to monopiles.

However, because the truss legs are made of a lower screw anchor that is rotated into the ground, and an upper leg, attached to the upper end of the screw anchor, the position and orientation of the leg relative to the torque tube may not always be the same. Also, the fitment between the top end of each upper leg and adapter or bearing support may also effect the distance between a preformed hole and the damper's upper mount. As a result, pre-forming damper bracket holes may not be possible when the single-axis tracker is supported by an EARTH TRUSS. In light of this problem, various embodiments of this disclosure provide a lower damper bracket for securely connecting a conventional tracker damper or gas spring to the leg of an EARTH TRUSS.

Unlike convention H-piles that have a standard web and flange geometry, the upper leg of the truss foundation has a uniform, rounded cross-section. Even though the ideal distance between the mounting portion at the ends of the damper bracket and the leg bracket location on the upper truss leg may be the same, the distance from the top of the leg to that location will vary based on factors such as leg angle, work point height, and fitment between the upper leg and the screw anchor and between the upper leg and the truss cap. Therefore, it may be impractical to simply preform holes or otherwise mark truss legs to receive a damper bracket as is done on with standard H-piles.

Rounded truss legs with uniform diameter enable a collar-like damper bracket to be flexibly positioned along the truss leg to insure that the leg bracket engages the truss leg at the correct position. However, because a collar bracket relies on friction to stay in place. This problem could be exacerbated by the fact that the truss foundation aligns the forces on the damper more closely with the leg than in with an H-pile. Over the two-decade plus life of the tracker, a friction fit may loosen, causing the damper bracket to slide on the leg. If this happens, the damper will no longer work, and the tracker will be vulnerable to damage from wind.

In recognition of these problems, it is an object of various embodiments of the invention to provide a damper assembly for single-axis trackers supported by truss foundations that requires little or no modification to existing tracker damper assemblies. It is another object of various embodiments of the invention to provide a damper bracket for truss legs that relies on mechanical engagement rather than friction alone to maintain the position of the damper bracket on the leg. It is still a further object of various embodiments of the invention to provide a damper assembly that may be adjusted to different positions on the truss leg. These and other objects of various embodiments of the invention will become apparent from the detailed description and appended drawing figures.

### BRIEF DESCRIPTION OF THE DRAWINGS

FIG. 1 shows a portion of a conventional single-axis tracker supported by a monopile foundation;

FIG. 2 shows a portion of a conventional single-axis tracker supported by a truss foundation with a truss leg damper assembly according to various embodiments of the invention;

FIG. 3 shows a portion of another conventional single-axis tracker supported by a truss foundation with a truss leg damper assembly according to various embodiments of the invention;

FIG. 4A shows a portion of a conventional single-axis tracker supported by another truss foundation with a truss leg damper assembly according to various embodiments of the invention;

FIG. 4B is a close-up view of components of a truss leg damper bracket of FIG. 3A;

FIG. 5 shows a portion of a conventional single-axis tracker supported by yet another truss foundation with a truss leg damper assembly according to various embodiments of the invention;

FIGS. 6 and 7 show multiple views of the truss leg damper assembly of FIG. 5;

FIG. 8 shows a portion of a conventional single-axis tracker supported by a truss foundation according to various embodiments of the invention;

FIG. 9 is a close-up view of components of the truss leg damper bracket of FIG. 8;

FIGS. 10A and 10B are further close-up views of the truss leg damper bracket of FIG. 8;

FIGS. 11A and 11B show components of an alignment jig for a truss leg damper assembly according to various embodiments of the invention; and

FIGS. 12A and 12B are force diagrams showing the forces generated by damping in a monopile foundation and a truss foundation, respectively.

### DETAILED DESCRIPTION

The following description is intended to convey a thorough understanding of the embodiments described by providing a number of specific embodiments and details involving A-frame foundations used to support single-axis solar trackers. It should be appreciated, however, that the present invention is not limited to these specific embodiments and details, which are exemplary only. It is further understood that one possessing ordinary skill in the art in light of known systems and methods, would appreciate the use of the invention for its intended purpose.

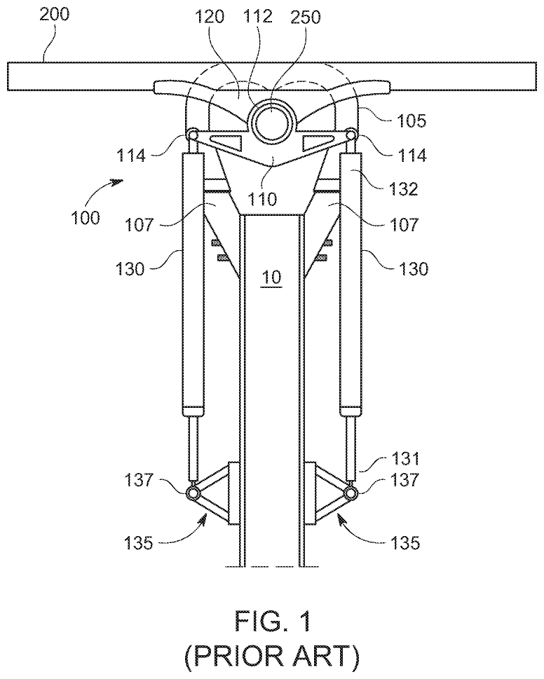

Starting with FIG. 1, this figure shows a portion of a conventional tracker system. The system shown in FIG. 1 is a conventional top-down or mechanically balanced tracker system 100, such as the NX Series single-axis tracker available from NEXTRACKER, INC. of Freemont, Calif. So-called top-down or mechanically balanced tracker systems suspend the torque tube (labeled “TT” in the figure) from a bearing pin in a bearing formed in a U-shaped bearing housing assembly (BHA) 105. In such a tracker, the torque tube is suspended from a bearing pin seated in an overhead bearing formed in a U-shaped bearing housing adapter (BHA). Though not shown, the portion of the torque tube that engages the drive motor is offset from the rest of the tube to be aligned with the bearing pin so that the rotational axis of the tracker is that of the pin, not of the suspended tube. This results in the torque tube swinging through an arc that is bounded on either side by the BHA. The designation “mechanically balanced” refers to the fact that the offset axis reduces and ideally eliminates any overturning moment, requiring very little energy to rotate the torque tube regardless of angle. By contrast, in a conventional single-axis tracker, the torque tube is aligned with the drive motor or drive assembly so that it rotates about its own axis within a series of aligned bearings supported by each foundation along the row. The various embodiments of the invention are compatible with either type of single-axis tracker although the disclosure is focused on first type.

The bearing housing assembly 105 sites on a pair of right-angle brackets 107 that are attached to respective flanges of a conventional W6×9 or W6×12 H-pile 10. Module bracket 120 attaches to torque tube 250 with a U-bolt and supports the frames of two adjacent photovoltaic (PV) modules 200. Though not shown, a drive motor is positioned somewhere along the length of the torque tube, offset from the main length of the tube, causing it to swing through an arc inside the space defined by bearing housing assembly 105. At every foundation or every Nth foundation, a pair of damper gas springs, such as spring 130 shown in FIG. 1 are mounted to brackets 135 attached to opposing flanges of the H-pile 10 at lower end 137 and to opposing arms 114 of damper bracket 110 at upper end 138. Damper bracket 110 is typically attached to torque tube 250 so that it rotates as torque tube 250 rotates. In this way, unintended resonance or rotation caused by wind gusts and turbulence impingent on the panels making up the array will be resisted and ideally extinguished before causing harm to tracker system 100.

In the monopile paradigm where the single-axis tracker is supported by a row of H-pile foundations, the orientation of the damper is inherently limited at least at the lower end because H-piles have a standard width, in most cases, about six inches. At the upper end, the damper bracket controls how far away the connection point is to the source of the dynamic force. Making the bracket longer in both directions (e.g., pushing the damper connection point out closer to the far edge of the PV module frame) will put the damper in a better position to resist the dynamic forces, however, it will increase the degree of moment on the damper bracket and on the H-pile, requiring both to made heaver and/or stronger.

Applicant has developed a novel truss foundation system for single-axis trackers known commercially as EARTH TRUSS. EARTH TRUSS consists of a pair of adjacent screw anchors driven at angles to one another to form an A-frame-shaped truss that is generally orthogonal to the orientation of the tracker row and torque tube. The legs may be formed from one or two pieces and have an external thread form at the below-ground. The open profile of the legs allows a mandrel, drill, or other tool to be inserted through their center during installation. The free ends of each leg may be joined with an adapter, bearing adapter or other structure that completes the truss foundation and incorporates or provides a platform for the torque tube bearing of the tracker.

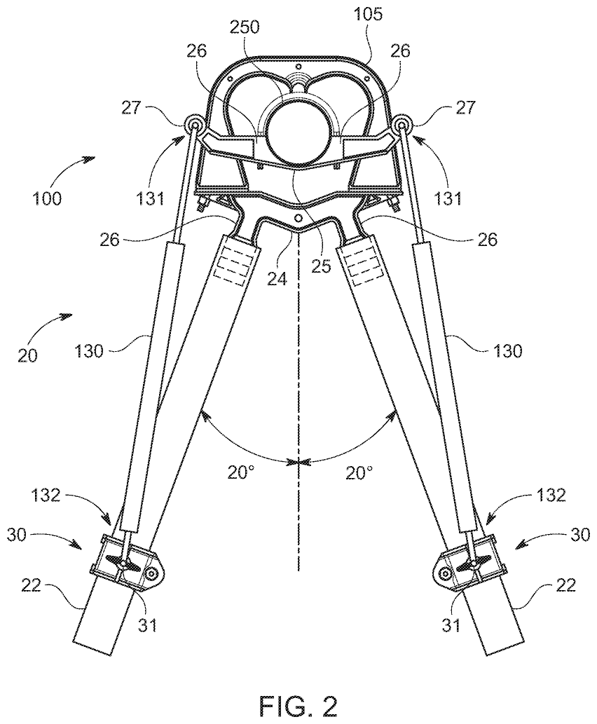

Turning now to FIG. 2, this figure shows a portion of single-axis tracker 100, such as that shown in FIG. 1, supported by the EARTH TRUSS foundation system 20 with an integrated truss leg damper system. In this example, the portion of truss foundation 20 includes legs 22 that are joined at their upper ends by truss cap or adapter 24. Connecting portions 26 are received within each leg 22 and a crimper or other tool is used to deform legs 22 around connection portions 26. Bearing housing assembly or BHA 105 sits on adapter 25 obviating the need for right angle brackets 107 shown in FIG. 1. Torque tube 250 hangs from a bearing pin seated in BHA 105. Dampers springs 130 are attached at their lower end 131 to truss leg 22 via leg bracket 30 and mounting post 31. Damper bracket 25 is rotatably attached to torque tube 250 at middle portion 26 with opposing arms 27 that extend away from middle portion 26 and provide a connection point for upper ends 131 of each damper spring 130. With this orientation, damper springs 130 have greater leverage than they do in the monopile paradigm without massively increasing the moment applied to the damper bracket. Moreover, because the resistance force is distributed on each leg and is substantially aligned with the leg's main axis, it is experienced as tension and compression in the leg rather than as bending moment as it is on a monopile. As shown in the figure, adapter or truss cap 24 separates truss legs 22 so that they are separated at an angle of 40-degrees. This corresponds to a truss leg angle of 70-degrees. It should be appreciated that in some embodiments, steeper leg angles may be used, such as, for example, to align the damper springs 130 more closely to with truss legs 22.

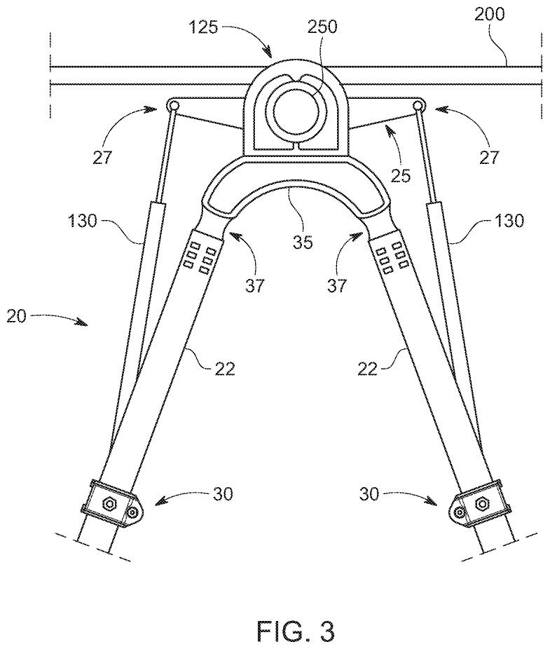

FIG. 3 shows a different commercially available tracker system, in this case, a bottom up style of tracker where torque tube 250 rotates about its own axis in bearing assembly 125, such as, for example, the DURATRACK HZ line of trackers from Array Technologies Inc. of Albuquerque, N. Mex. Here, truss foundation 20 consists of adjacent truss legs 22 joined together by adapter or truss cap 35. Adapter 35 show here has a pair of connecting portions 37 that received in respective ones of truss legs 22. In various embodiments, legs 22 may be crimped over connecting portions 37 to lock the truss structure together. The ATI tracker system includes bearing assembly 125 with a circular bearing that enables torque tube 125 to rotate about its own axis. Bearing assembly 125 may be attached to adapter 36 with one or more bolts (now shown).

Torque tube damper bracket 25 includes a pair of opposing arms 27 that extend away from the torque tube. These arms 27 provide a connection point for the upper end of damper springs 130. The lower ends of damper springs 130 are connected to respective ones of truss legs 22 via damper leg brackets 30. As discussed in greater detail herein, foundation 20 shown in FIGS. 2 and 3 force form damper springs 130 into substantially axial forces of tension and compression in truss legs 22.

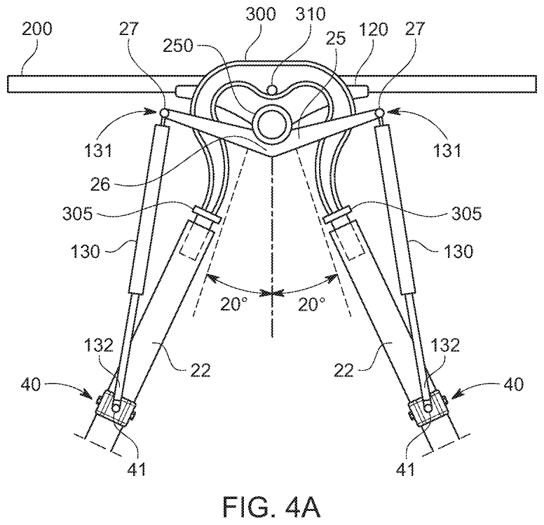

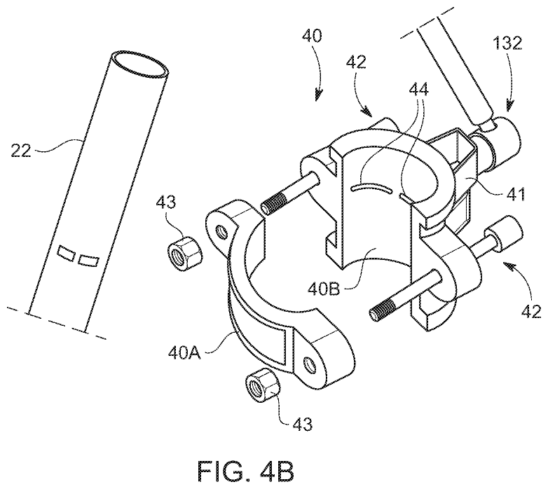

FIG. 4A shows yet another single axis tracker supported by a truss foundation. As with the tracker shown in FIG. 2, this tracker is a top-down or mechanically balanced style of tracker such as the NX Series of solar trackers from NEXTracker, Inc. The integration between the truss foundation differs from that shown in FIG. 2 in that truss legs 22 are joined together with bearing adapter 300. Bearing adapter 300, as shown, as a generally cardioid shaped member that terminates in connecting portions 305 that are received in truss legs 22 in a manner similar to adapters 24 and 35. Damper springs 130 are connected at their upper ends 131 to arms 27 of torque tube bracket 25. Module bracket 120 is also connected to torque tube 250 to hold modules 200 against torque tube 250 so as to rotate with the rotation of torque tube 250. At their respective lower ends 132, damper springs 130 are connected to mounting studs 41 on truss leg bracket or clamp 40. In the figure, bearing adapter 300 separates truss legs by an angle of 40-degrees, corresponding to leg angles of 70-degrees with respect to horizontal. It should be appreciated that other angles may also be used.

Turning to FIG. 4B, this figure shows a portion of one of legs 22 and a close-up partially exploded view of leg damper bracket 40 attaching the lower end 132 of the damper spring 130 to truss leg 22. As shown, truss leg 22 has a pair of crimped dimples which, in various embodiments, may be used as timing marks to show where to attach damper bracket 40 and to provide recesses to receive corresponding projections formed on the inner surface of bracket 40 for a mechanical engagement. This positive mechanical engagement will provide greater resistance to movement than friction alone. It should be appreciated, however, that in other embodiments, leg 22 may have a through-hole pre-formed through both sides to set the location of damper bracket 40 and the bracket may be attached by passing a bolt or other fastener through the bracket and the through-hole. The particular mechanism used to attach damper bracket 40 to truss leg 22 is a design choice.

As shown, damper bracket 40 is a two-piece structure made up of halves 40A and 40B. Both 40A and B have holes on either side that receive bolts 42 that are locked down with nuts 43, effectively clamping halve 40A and 40B to truss leg 22. In various embodiments, projections 44 may be built into the inner surface of section 40B to orient bracket 40 at a certain point along leg 22. Mount 41 projects out of half 40B and is received in the lower end 132 of damper spring 130 to hold it in place

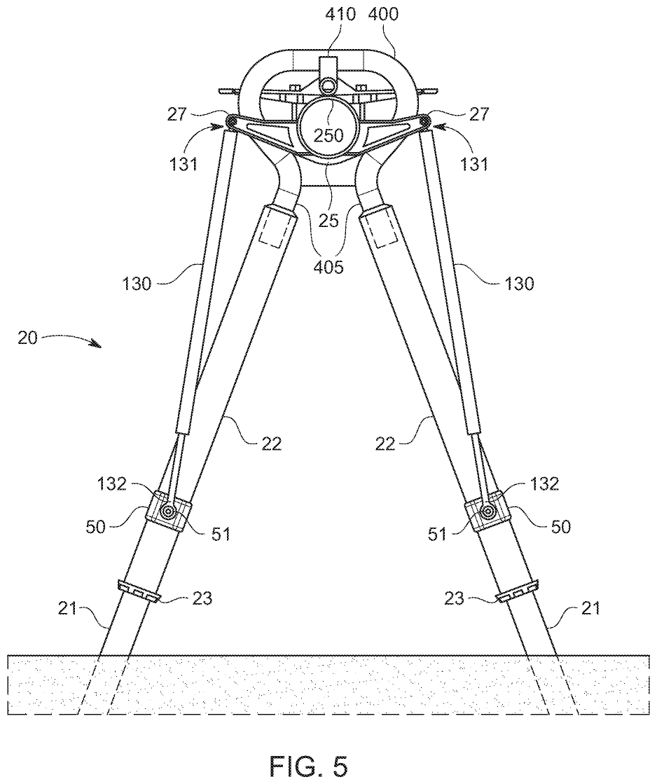

Turning now to FIG. 5, this figure shows truss foundation 20 supporting another single axis tracker. Truss foundation 20 consist of truss legs that are made up of upper leg portions 22 axially attached to screw anchors 21 via driving couplers 23. In various embodiments, driving couplers 23 are attached to the upper ends of screw anchors 21 and provide features for driving screw anchors 21 into the ground as well as features that enable upper leg portions 23 to be sleeved over them, extending screw anchors 21 to form a complete truss leg. Upper legs 22 may be crimped, screwed, bolted, or otherwise mechanically fastened to driving couplers 23 and/or the screw anchor. Coupler 23 may be a separate component. Alternatively, features of the coupler may be stamped, welded, or otherwise formed at the upper end of crew anchors 21.

Each upper leg 22 is joined at its upper end to bearing adapter 400. Bearing adapter 400 is a cardioid-shaped structure with an integral bearing 410 and a pair of connecting portions 405. As shown, connecting portions 405 are received within respective one of the upper legs 22 and then crimped, bolted, or otherwise fasted to hold them in place. Bearing adapter 400 completes the truss foundation but is also a component of the single-axis tracker. Bearing adapter 400 includes integral bearing 410 that receives a rotating member, such as, for example, in the NEXTracker NX tracker, a bearing pin. The bearing pin is inserted into bearing 410 so that it can rotate in place and, to some extent, to slide axially within bearing 400, as torque tube 250 swings through its rotational arc. In this exemplary system, torque tube 250 is suspended from the bearing by one or more torque tube support brackets (not shown). A module bracket is also attached to the torque tube via a U-bolt and is used to secure photovoltaic modules or solar panels to tube 250. A drive assembly positioned somewhere along torque tube 250 causes it to swing through an arc in the cardioid-shaped space defined by bearing adapter 400 to move the panels attached to torque tube 250 from an East-facing to a West-facing orientation each day to keep them on-sun. Torque tube bracket 25 functions in the same manner as shown in other embodiments, with arms 27 extending from middle portion 26 to provide a connection to upper ends 131 of damper springs 130. Lower ends 132 of each damper spring 130 are connected to mounting stud 51 on each truss leg damper bracket 50.

The single-axis tracker shown in FIG. 5, also includes a damper assembly that consists of torque tube bracket 25 with a middle portion 26 that approximates the outer geometry of torque tube 250 and is affixed to torque tube 250 so that as the tube swings through its arc, torque tube bracket 25 also moves. Damper springs or struts 130 as they are also called, are attached to respective arms 27 of torque tube bracket 25 and extend down to corresponding truss leg damper brackets 50 located on respective truss legs 22 to complete the assembly. Damper springs 130 allow the torque tube 250 to move under power of the drive motor but will retard unintended impulse movements and oscillations.

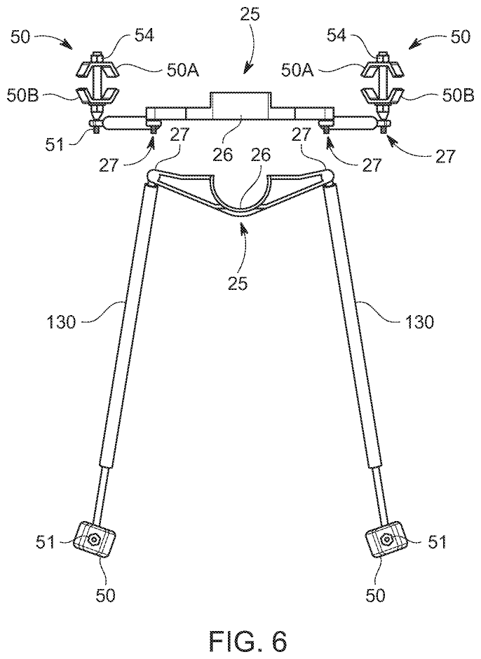

FIGS. 6 and 7 show the truss damper assembly of FIGS. 5 in greater detail. FIG. 6 provides top and front views respectively, whereas FIG. 7 shows a perspective view of the assembly and exploded view of truss leg damper bracket 50. As shown, torque tube bracket 25 has a middle portion 26 with a semi-circular profile that is intended to match the geometry of the torque tube in cross section. It should be appreciated that some torque tubes may have a hexagonal cross-section rather than a circular one, in which case, torque tube bracket 25 may have a profile that matches it. A pair of opposing arms 27 extend away from middle portion 26 of the bracket. When attached to a torque tube, arms 27 will extend orthogonally on either side of the tube. The end of each bracket arm 27 includes a connecting portion such as a threaded post, a rounded post, or other suitable connector commonly used to support damper spring 130. In the shown assembly, damper springs 130 extend downward in the general direction of each truss leg 22 and are attached to truss leg 22 via a truss leg damper bracket 50. Damper bracket 50, shown in greater detail in FIG. 3, includes two-piece clamps structure made up of halves 50A and 50B joined via bolt 51. It should be appreciated that bracket 50 may also be a single piece with a hinge or other articulating connector joining halves 50A and 50B. Also, although bracket 50 shown here has facets rather than a circular profile, in other embodiments it may have a circular profile. The specific profile chosen is a design choice. In various embodiments, bolt 51 passes through holes pre-drilled in each leg 22 to transfer loads absorbed by the gas springs into truss legs 22 rather than relying on friction alone to maintain the location of bracket 50 along leg 22. In various embodiments, bolt 51 includes leg portion 54 that passes through halves 50A and 50B as well as leg 22. Bolt 55 is attached to the distal threaded end to secure halves 50A and 50B around the truss leg. As shown, the other end of bolt 51 includes threaded mounting stud 52. Mounting stud 52 provides a fixed connection point for the lower end of damper spring 130.

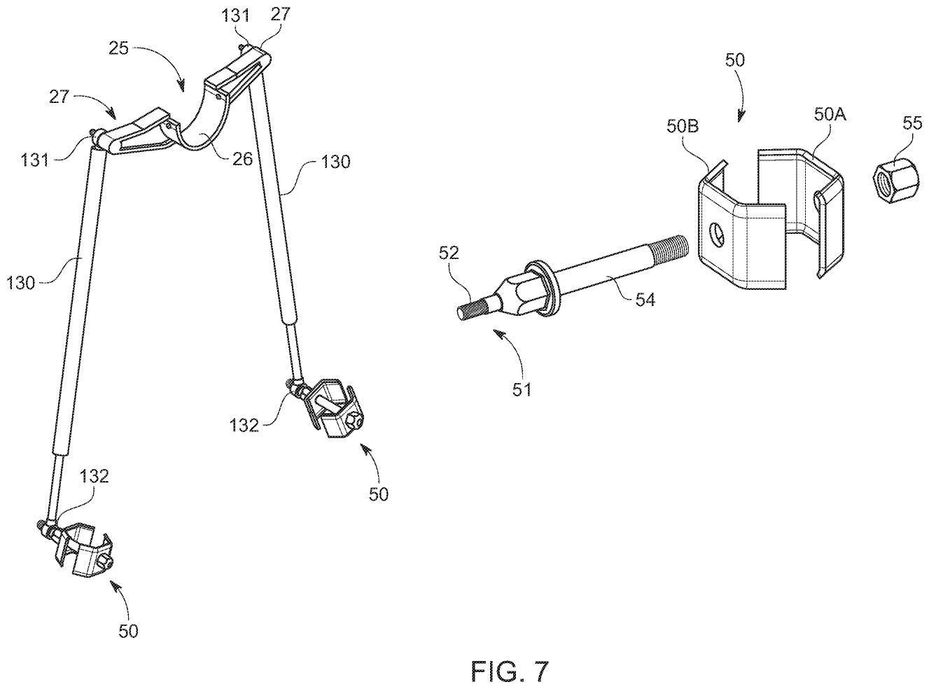

FIG. 8 shows another single-axis tracker supported by a truss foundation according to various embodiments of the invention. Foundation 20 shown here is substantially the same as other truss foundations shown in preceding figures and tracker is substantially the same as that shown in FIGS. 5. For example, the tracker is top-down style of tracker with bearing adapter 500 joining truss legs 22 and providing bearing 510 from which torque tube 250 is suspended. Cardioid-shaped bearing adapter 510 terminates in connecting portions 505, which, are received within the open end of upper legs 22. As shown, crimp joints secure legs 22 to bearing adapter 510 at connecting portions 505, however, other means may be used to secure these components. Damper springs 130 extend from arms 27 of torque tube bracket 25 down to leg damper brackets 60 positioned toward the lower end of each upper leg 22.

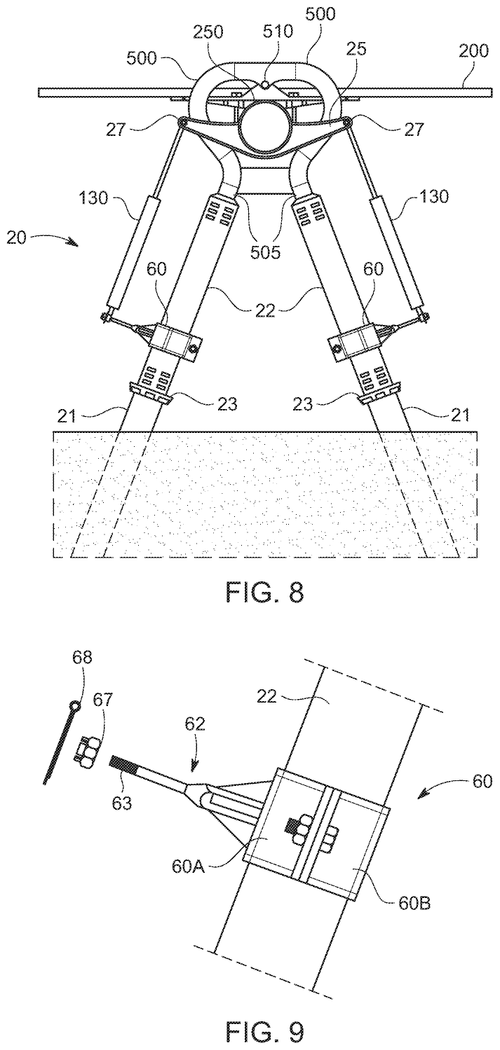

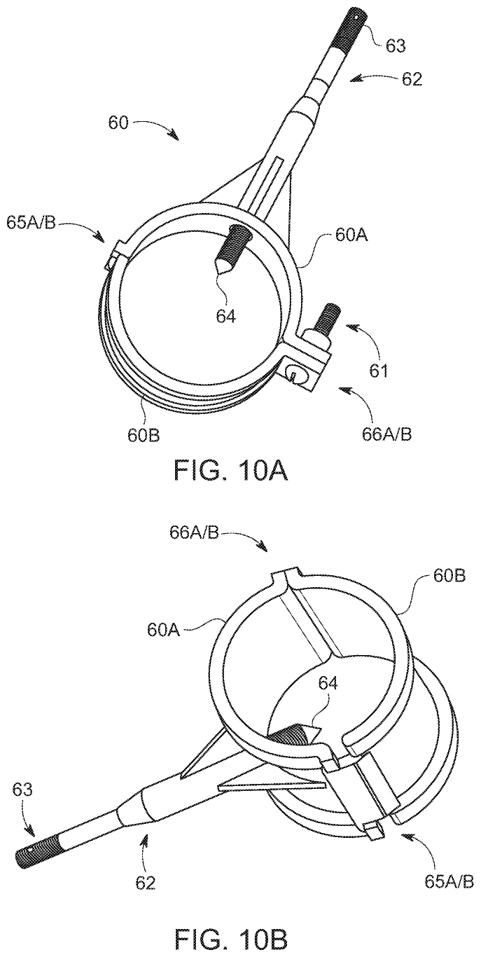

FIGS. 9, 10A and 10B provide close-up and exploded views of damper leg bracket 60. As with other leg brackets, leg bracket 60 is of two-piece construction, consisting of halves 60A and 60B that are joined together to form a collar with a rounded internal geometry around truss leg 22. Each half 60A/60B has a rounded inner surface, flange portion 66A/B and hinge portion 65A/B. When joined, flange portions 65A/B overlap so that a Huck bolt or other mechanical fastener such as bolt 61 can pass through each to lock them together as unitary structure 60. Portion 60A has mounting stud 62 projecting away from the outer surface that terminates in threaded post 63. Threaded post 63 receives the lower end of damper spring 130 as well as a lock nut 67 and cotter pin 68 to keep it in place. A pinhole formed in threaded post 63 receives cotter pin 68 to retain lock nut 67 after nut 67 has been threaded on.

In various embodiments, the inner surface of one of the halves, half 60A as shown in the drawings, has a recess in it that receives the head of self-tapping set screw 64 used to orient the location of bracket 60. This allows halves 60A/B of bracket 60 to be joined together over truss leg 22 so that it is correctly positioned and unable to move axially along leg 22, even under load. As shown this recess is co-located with the mounting stud 62 so as not to compromise the strength of half 60A. It should be appreciated, however, that the location of the recess is a design choice. It may be desirable to have the recess located in another portion of damper mounting bracket 60. Such variations are within the scope of the various embodiments of the invention.

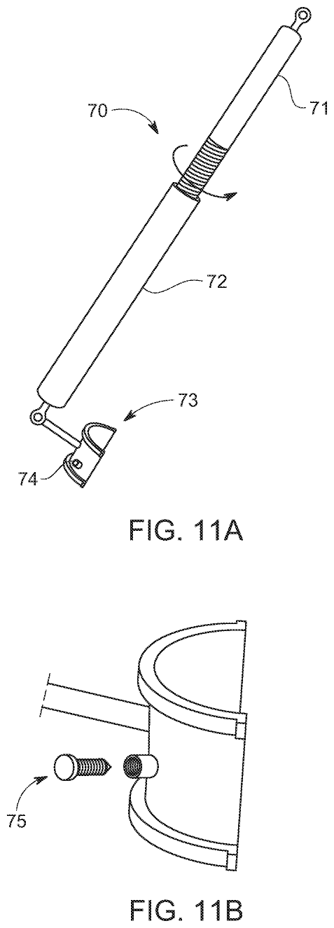

FIGS. 11A and 11B show exemplary jig 70 that may be used to locate set screw 64. In various embodiments, jig 70 will approximate the desired length of the damper spring to be used on the tracker when the array is at the stow or zero-degree tilt position. Top end 71 of jig 70 may be attached to a post or other feature on the damper bracket attached to the torque tube. Then, lower end 72 is positioned on the truss leg so that set screw aligner 74 is resting on the face of the truss leg and at the orientation desired by tracker manufacturer. Aligner 74 may be curved to match the curve of the truss leg so that it fits flush against the surface of the leg. In various embodiments, the alignment jig 70 may be adjustable to shorten or extend its length so that it can accommodate different lengths of damper springs.

Once aligner 74 is resting against the surface of the leg, an installer may use a battery-operated impact driver or other suitable tool to drive the self-tapping set screw 75 into the truss leg through the opening provided in aligner 74. In various embodiments, the opening in aligner 74 may be slightly larger than the head of screw 75 to enable it to be driven into place. With a combination of torque, downforce, and/or hammering, set screw 75 will be driven into the truss leg until the head or other stop meets the leg surface. Then, jig 70 is simply lifted away from the truss leg, leaving the set screw 70 in place. Truss leg damper bracket 60 may then be opened around the leg and closed until the head of set screw 70 is aligned with the opening in the inner surface of one of the bracket half 60A. Fitment between screw head 75 and the opening allows the bracket to fully close so that the installer can drive a Huck bolt or other suitable fastener through flanges 66A/B to lock them together. The damper spring may be installed at that point or installed later by connecting the upper end of the damper spring to the torque tube damper bracket and the lower end to threaded mounting post 63.

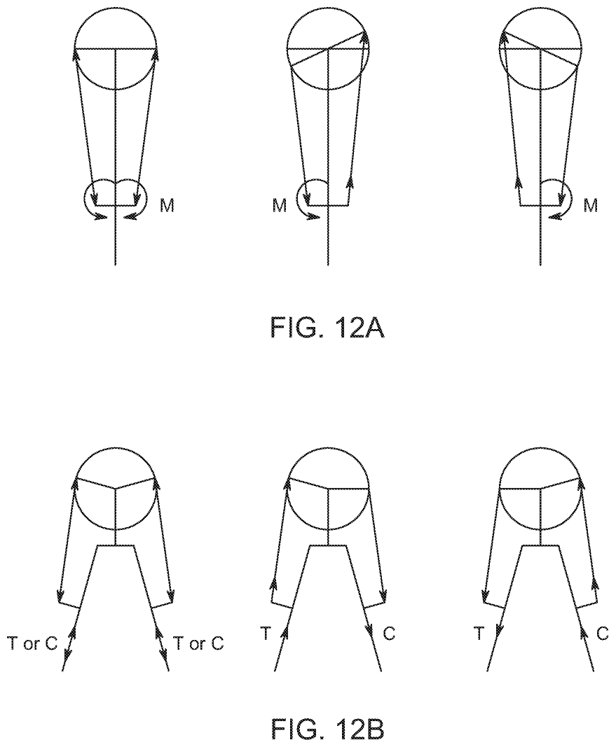

Turning now to FIGS. 12A and 12B, these figures are force diagrams showing the different forces experienced during damping by a conventional monopile foundation versus a truss foundation according to various embodiments of the invention. Starting with 12A, when connected to a single H-pile, the damper springs terminate at damper brackets located on either side of the pile. As wind strikes the array, trying to move it clockwise or counterclockwise, the springs will impart opposing forces to the H-pile via the damper brackets supporting the springs. As one damper pushes down, the other will pull up on the same H-pile.

With the truss foundation of FIG. 12B, the torque tube bracket may orient the upper end of each damper spring along the same circle circumscribed by the torque tube bracket but at the lower end, the forces are not translated into opposing sides of the same single structural member. Instead, these forces are mostly translated into axial forces in the legs. The fact that each damper spring is more closely aligned with the axis of the truss leg, insures that the force due to damping the torque tube is felt mostly as tension and compression (T&C) in the truss legs. Distributing damping resistance in two legs and aligning the force vector with each leg also enables less steel to be used to support the same tracker.

It should be appreciated that in at least one variant, jig 70 may orient bracket 60 itself or one half 60A/B of bracket 60 rather than mimicking its geometry. For example, the set screw aligner portion 73 of jig 70 may be replaced with the portion 60A containing the mounting stud. An opening or yoke in the lower end of jig 70 may be slid over mounting stud 62 and then used to position portion 60A on the leg directly. In such a variant, self-tapping screw 74 may be driven through a hole in portion 60A until it bottoms out against the bracket, securing it to the truss leg at the correct location. Then, jig 70 can be removed by simply sliding it off stud 62. If second half 60B of bracket 60 is not already attached, it may be attached at that point. Otherwise, the installer may simply bolt halves 60A/B together, locking bracket 60 into place.

The embodiments of the present inventions are not to be limited in scope by the specific embodiments described herein. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

1. A single-axis solar tracker comprising:
a rotating member;
a bearing receiving and rotatably supporting the rotating member;
a multi-leg truss foundation supporting the bearing;
and a damper connected at a first end to move in response to movement of the torque tube and connected at a second opposing end, to a fixed point attached to at least one leg of the truss foundation, wherein the damper resists movement of the torque tube by translating force experienced by the damper substantially into an axial force on the at least on leg.

2. The tracker according to claim 1, further comprising an adapter joining the legs of the multi-leg truss foundation wherein the rotating member is a bearing pin seated in a bearing formed in a bearing housing assembly attached to the adapter.

3. The tracker according to claim 1, wherein the rotating member is a bearing pin seated in a bearing adapter joining the legs of the multi-leg truss foundation.

4. The tracker according to claim 1, further comprising an adapter joining the legs of the multi-leg truss foundation wherein the rotating member is a section of torque tube seated in the bearing attached to the adapter.

5. The tracker according to claim 1, wherein the fixed point attached to the at least one leg of the truss foundation comprises a leg bracket assembly.

6. The tracker according to claim 5, wherein the leg bracket assembly includes at least one penetrating feature that prevents the leg bracket from sliding along the at least one leg.

7. The tracker according to claim 1, further comprising an upper damper bracket connected at a middle portion to the torque tube and having at least one arm portion extending away from the middle portion that is connected to the first end of the damper.

8. A damper assembly for a truss foundation comprising:
a torque tube bracket having a first portion adapted to connect to and rotate with a torque tube, and at least one arm portion extending away from the first portion;
a truss leg bracket adapted to connect to truss leg and to support a second end of one of the elongated damper with a penetrating connection; and
an elongated damper spring adapted to connected to the at least one arm portion at a first end and to the truss leg bracket at an opposing second end.

9. The damper assembly according to claim 8, wherein the damper spring connects to the truss leg bracket at an angle that substantially translates axial forces from the damper into axial forces in the leg.

10. The damper assembly according to claim 8, wherein the truss leg bracket comprises a two-piece assembly that clamps onto the at least one truss leg.

11. The damper assembly according to claim 10, wherein the truss leg bracket comprises at least one penetrating feature that engages the at least one truss leg.

12. The damper assembly according to claim 11, wherein the at least one penetrating feature comprises a projection formed on an inner surface of at least one piece of the two-piece assembly.

13. The damper assembly according to claim 11, wherein the at least one penetrating feature comprises a bolt that passes through the at least one truss leg and each piece of the two-piece assembly.

14. The damper assembly according to claim 11, wherein the at least one penetrating feature comprises a stud passing that at a first end penetrates the at least one leg, and at a second end provides a connection point for the damper spring.

15. A damper bracket for a truss foundation comprising:
a collar portion comprising a pair opposing halves that join together to form a rounded collar; and
a self-tapping set screw, wherein the one of the opposing halves comprises a recess for receiving a head of the self-tapping set screw after the screw is driven into a truss leg.

16. The damper bracket according to claim 15, wherein the pair of opposing halves comprise respective flanges that overlap to receive a mechanical fastener when the halves are clamped around a truss leg.

17. The damper bracket according to claim 15, wherein one of the opposing halves comprises a mounting stud projecting from an outer surface thereof to providing a connection point for a damper spring.

18. The damper bracket according to claim 15, wherein the pair of opposing halves comprise respective hinge portions that interlock when the halves are clamped around a truss leg.
